(19) United States
(12) Patent Application Publication
(10) Pub. No.: US 2005/0081223 A1
(43) Pub. Date: Apr. 14, 2005

(54) Optical disk drive provided with a flexible member to prevent scratch done onto an optical disk

(75) Inventors: Tsung-Jung Kuo, Hsinchu City (TW); Jui-Chiang Lin, Hsinchu City (TW)

Correspondence Address: BIRCH STEWART KOLASCH & BIRCH, PO BOX 747, FALLS CHURCH, VA, 22040-0747, US

(73) Assignee: Lite-On it Corporation

(21) Appl. No.: 11/002,217

(22) Filed: Dec. 3, 2004

(30) Foreign Application Priority Data
Feb. 12, 2003 (TW) 92135172

(51) Int. Cl. G11B 17/04; G11B 33/02

(52) U.S. Cl. 720/647; 720/619

(57) ABSTRACT

A disk drive includes a casing having an entrance-and-exit slot, a chassis disposed stationarily within the casing to extend in a disk-traveling route, a disk transport mechanism disposed adjacent to and cooperating with the chassis for drawing a disk into the casing and ejecting the disk out of the casing via the entrance-and-exit slot, and a soft flexible member disposed within the casing adjacent to the disk-traveling route. The flexible member is capable of preventing the disk from being scratched during traveling of the disk along the disk-traveling route.

### FIELD OF THE INVENTION

The invention relates to a disk drive of slot-in type, more particularly to an optical disk drive of slot-in type provided with a soft flexible member to prevent scratch done onto an optical disk during disk inserting operation and disk ejecting operation.

### BACKGROUND OF THE INVENTION

An optical disk drive of slot-in type is generally installed in a notebook computer or in an audio-and-video instrument of an automobile for reproducing the information recorded in an optical disk, such as playing songs from a CD.

Referring to FIGS. 1 and 2, perspective and partly side views of a conventional disk drive 1 of slot-in type are shown to include a casing 2 formed with a disk entrance-and-exit slot 21, and a disk transport mechanism 3 disposed in the casing 2 adjacent to the entrance-and-exit slot 21. The disk transport mechanism 3 includes a gear transmission unit (not visible), a roller-mounting frame 32 disposed within and mounted swingably to the casing 2, a transport roller 31 journalled on the roller-mounting frame 32 and operably connected to the gear transmission unit, and a chassis 4 disposed stationarily above the transport roller 31 and slidably contacting the transport roller 31 in such a manner that rotation of the gear transmission unit actuates the transport roller 31 so as to draw the disk 9 into and eject the disk 9 from the casing 2 via the entrance-and-exit slot 21 due to applying force on the optical disk 9, as shown in FIGS. 2 and 4. The roller-mounting frame 32 is swingable relative to the casing 2 between a shielding position (reading and/or writing position), in which, the stopping bent ends of the roller-mounting frame 32 are disposed midway to a disk-traveling route (the chassis 4) while the transport roller 31 is spaced away from the chassis 4 (see FIG. 3), and a rotating position, in which, the stopping bent ends of the roller-mounting frame 32 are spaced apart from the disk-traveling route (see FIGS. 2 and 4) while the transport roller 31 is disposed adjacent to the chassis 4 for rotation thereof.

One disadvantage resulting from the use of the aforesaid disk drive is that the optical disk 9 may be scratched due to many reasons during inserting and ejecting operations and due to untimely swinging of the roller-mounting frame 32 during vibration of the casing 2, as shown in FIG. 5.

### SUMMARY OF THE INVENTION

The object of the present invention is to provide a disk drive of slot-in type provided with a soft flexible member to prevent scratch done onto an optical disk during disk inserting operation and disk ejecting operation.

A disk drive according to the present invention includes: a casing having an entrance-and-exit slot; a chassis disposed stationarily within the casing to extend in a disk-traveling route aligned with the entrance-and-exit slot; a disk transport mechanism disposed adjacent to and cooperating with the chassis for drawing a disk into the casing and ejecting the disk out of the casing via the entrance-and-exit slot; and a soft flexible member disposed within the casing adjacent to the disk-traveling route. The flexible member is adapted to prevent the disk from being scratched during traveling of the disk along the disk-traveling route.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 shows a perspective view a conventional disk drive of slot-in type;

FIG. 2 is a partly side view of the conventional disk drive, illustrating how an optical disk is drawn into a casing upon rotation of a transport roller;

FIG. 3 is a partly side view of the conventional disk drive, illustrating a state when the optical disk is disposed in a reading position;

FIG. 4 is a partly side view of the conventional disk drive with the casing removed, illustrating how the optical disk is ejected from the casing upon rotation of the transport roller;

FIG. 5 is a partly side view of the conventional disk drive with the casing removed, illustrating how the optical disk is scratched due to untimely swinging of a roller-mounting frame within the casing;

FIG. 6 is a perspective view a disk drive of slot-in type according to the present invention;

FIG. 7 is a perspective and partly exploded view with a casing removed, illustrating a disk transport mechanism disposed within the casing;

FIG. 8 is a bottom view of the disk drive according to the present invention with the casing removed, illustrating how the optical disk is drawn into the casing;

FIG. 9 is a perspective view of a roller-mounting frame employed in the disk transport mechanism of the disk drive according to the present invention;

FIG. 10 is a side view of the first embodiment of the disk drive according to the present invention;

FIG. 11 is a side view of the second embodiment of the disk drive according to the present invention;

FIG. 12 shows a bottom side view of a chassis employed in the second embodiment of the disk drive according to the present invention;

FIG. 13 is a side view of the third embodiment of the disk drive according to the present invention;

FIG. 14 is a side view of the third embodiment of the disk drive according to the present invention, illustrating the optical disk at a reading position;

FIG. 15 is a side view of the third embodiment of the disk drive according to the present invention, illustrating how the optical disk is prevented from being scratched by the roller-mounting frame due to untimely swinging action of the former during the disk inserting operation;

FIG. 16 is a side view of the third embodiment of the disk drive according to the present invention, illustrating how the optical disk is prevented from being scratched by the roller-mounting frame due to gravity of disk during the removing operation;

FIG. 17 shows a diagram representing a first soft flexible member employed in the disk drive of the present invention;

FIG. 18 shows a diagram representing a second soft flexible member employed in the disk drive of the present invention; and

FIG. 19 shows a diagram representing a third soft flexible member employed in the disk drive of the present invention.

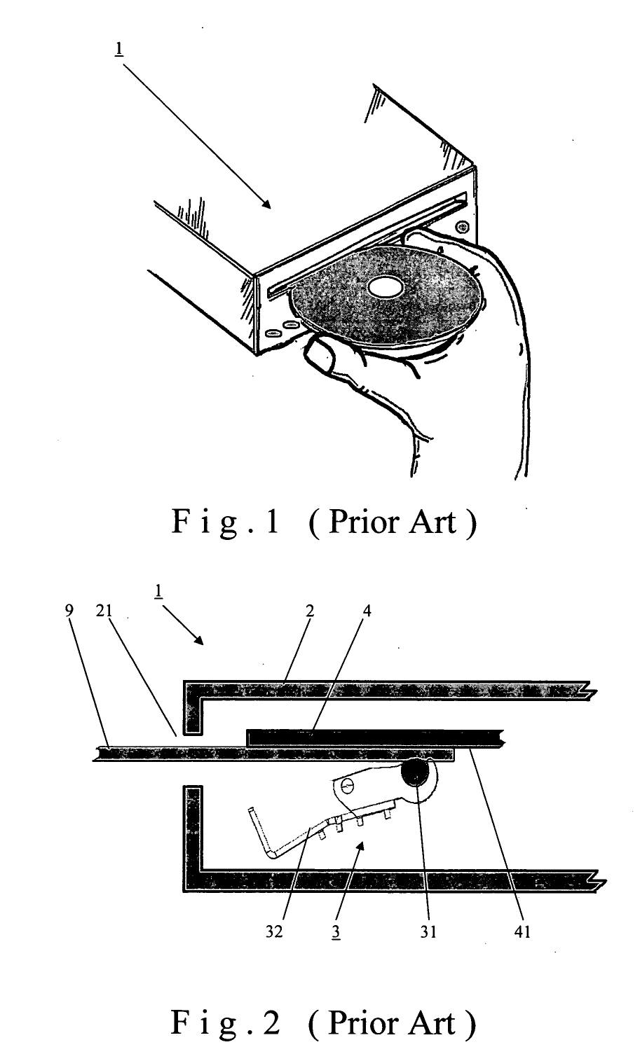

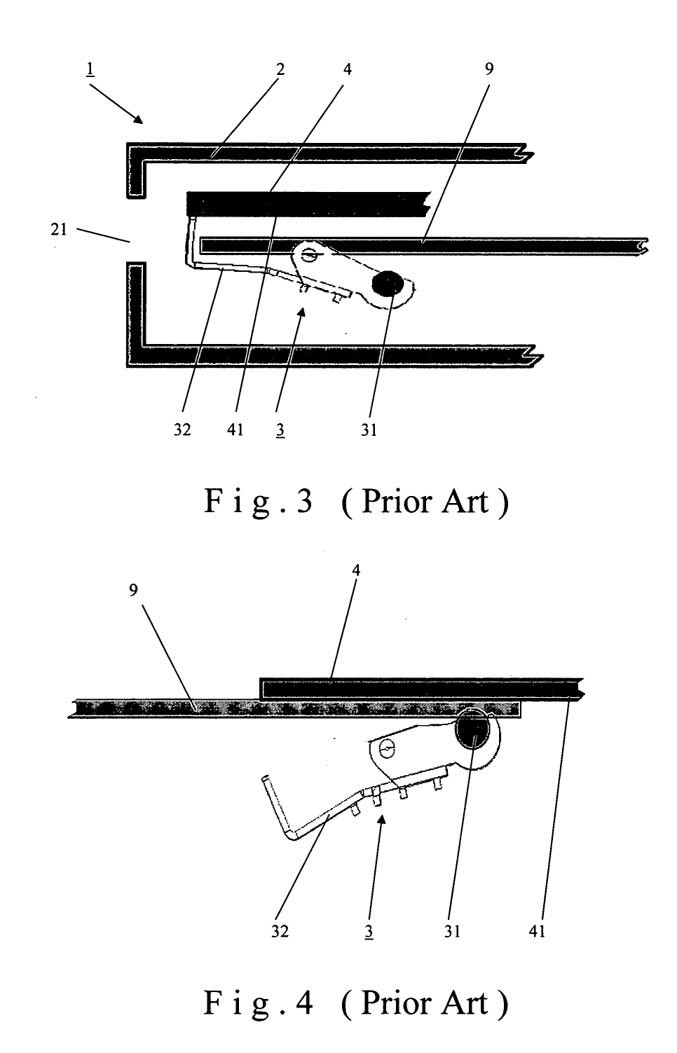

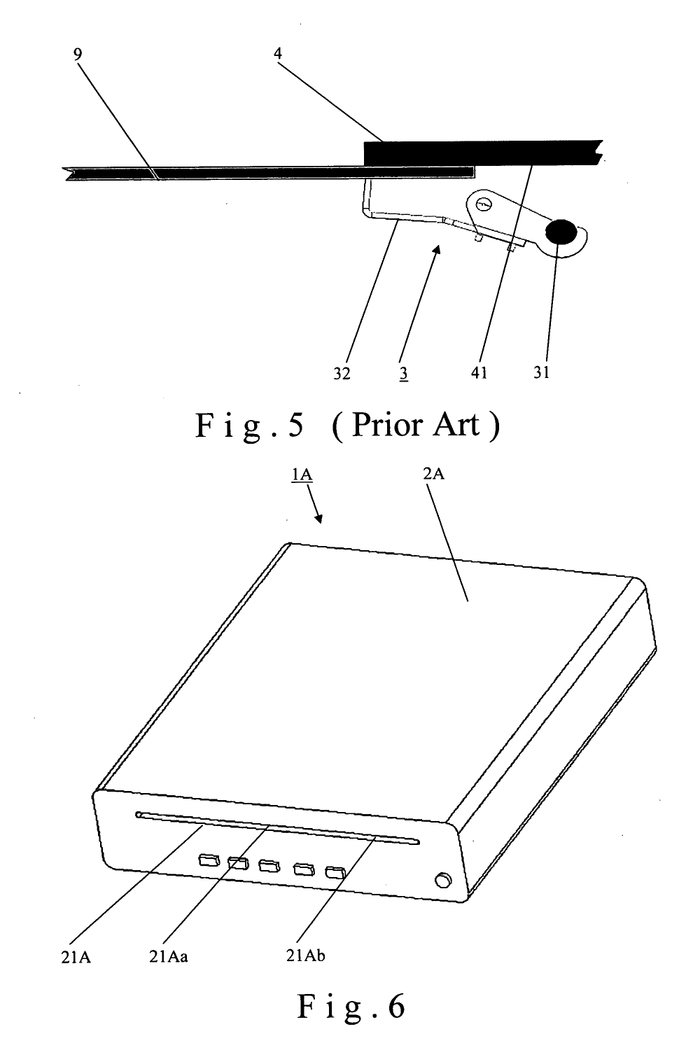

### DETAILED DESCCRIPTIONS OF THE PREFERRED EMBODIMENTS

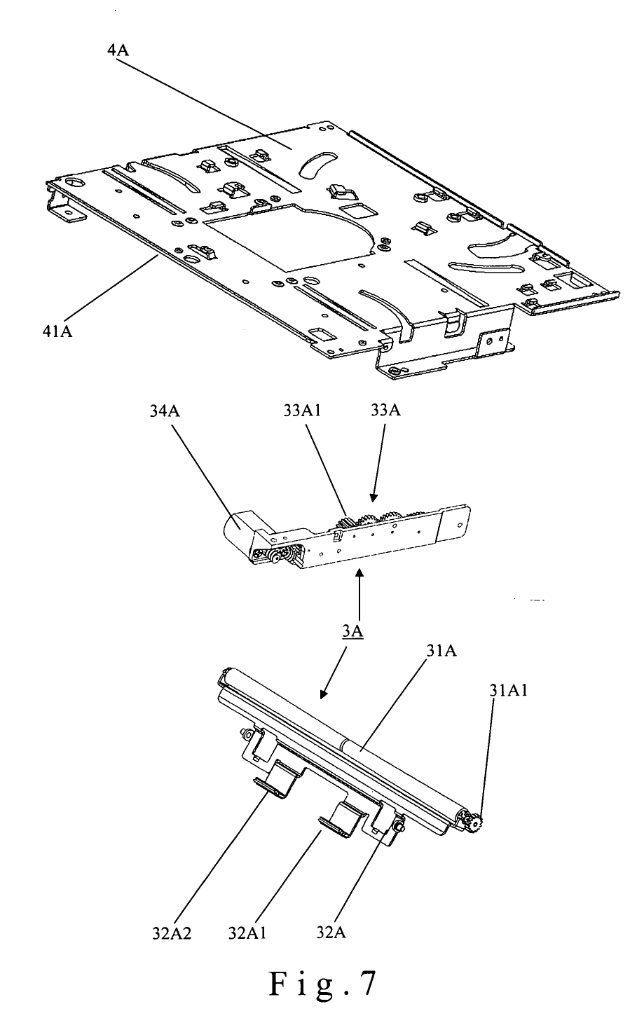

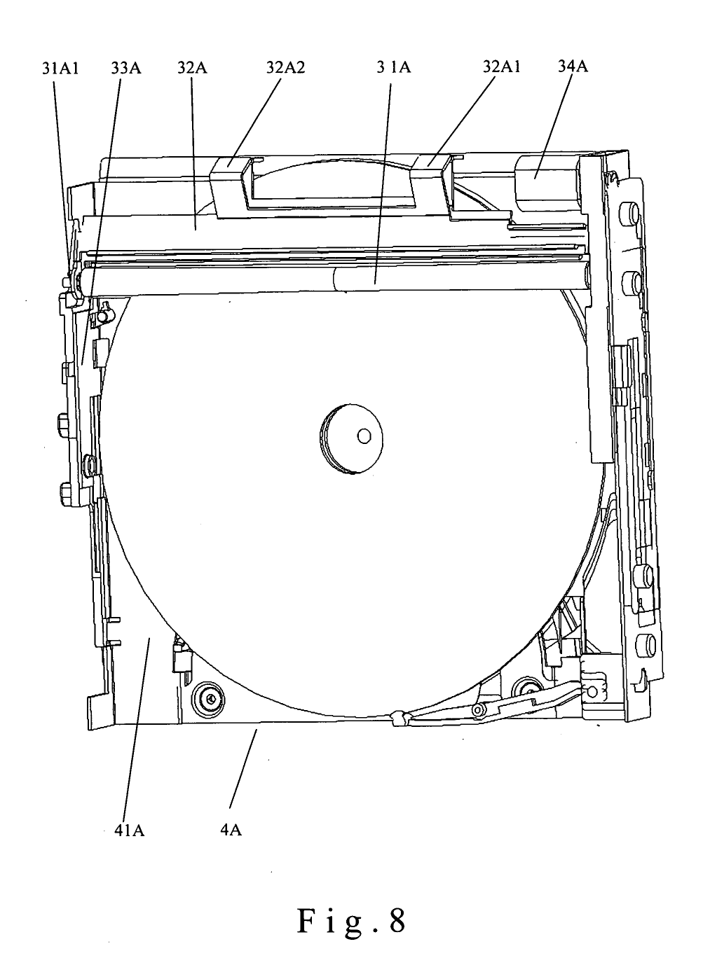

Referring to FIGS. 6 and 7, a perspective and exploded views of an optical disk drive 1A of slot-in type is shown and generally installed in a notebook computer (not shown) or in an audio-and-video instrument of an automobile for reproducing the information recorded in an optical disk 9 (see FIG. 8), such as playing songs from a CD.

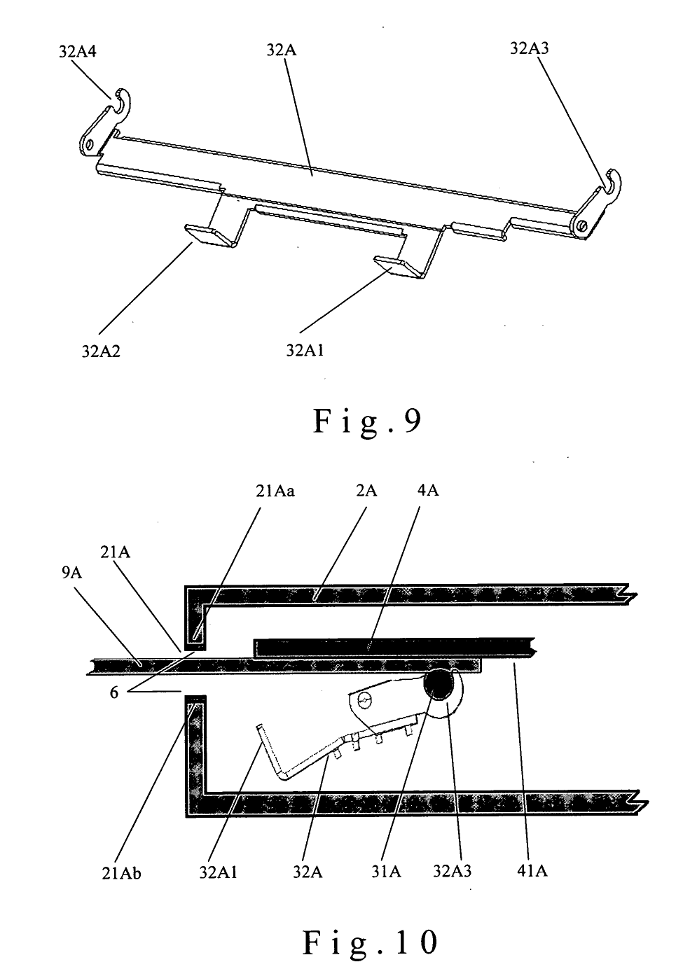

As illustrated, the optical disk drive 1A includes a casing 2A formed with an entrance-and-exit slot 21A, a disk transport mechanism 3A, a chassis 4A, and a soft flexible member 6 preferably made from cotton flannel or rubber. The chassis 4A is disposed stationarily within the casing 2A, and extends along a disk-traveling route aligned with the entrance-and-exit slot 21A. A reading and/or writing head (not shown) is mounted movably on the chassis 4A for reading and/or writing the information recorded in an optical disk. The disk transport mechanism 3A includes a gear transmission unit 33A mounted at one side of the chassis 4A (see FIG. 8) and having a transmission gear 33A1 and a driving motor 34A (see FIG. 7), a roller-mounting frame 32A mounted swingably within the casing 2A below the chassis 4A, and a transport roller 31A journalled on two roller-holding arms 32A3, 32A4 of the roller-mounting frame 32A (see FIGS. 7 and 9). The transport roller 31A is provided with a driven wheel 31A1 in mesh with the transmission gear 33A1 of the gear transmission unit 33A in such a manner that activation the driving motor 34A results in rotation of the transport roller 31A so as to draw an optical disk 9A into and eject the disk 9A from the casing 2A via the entrance-and-exit slot 21A in the casing 2A due to applying force on the optical disk 9A, as best shown in FIG. 10.

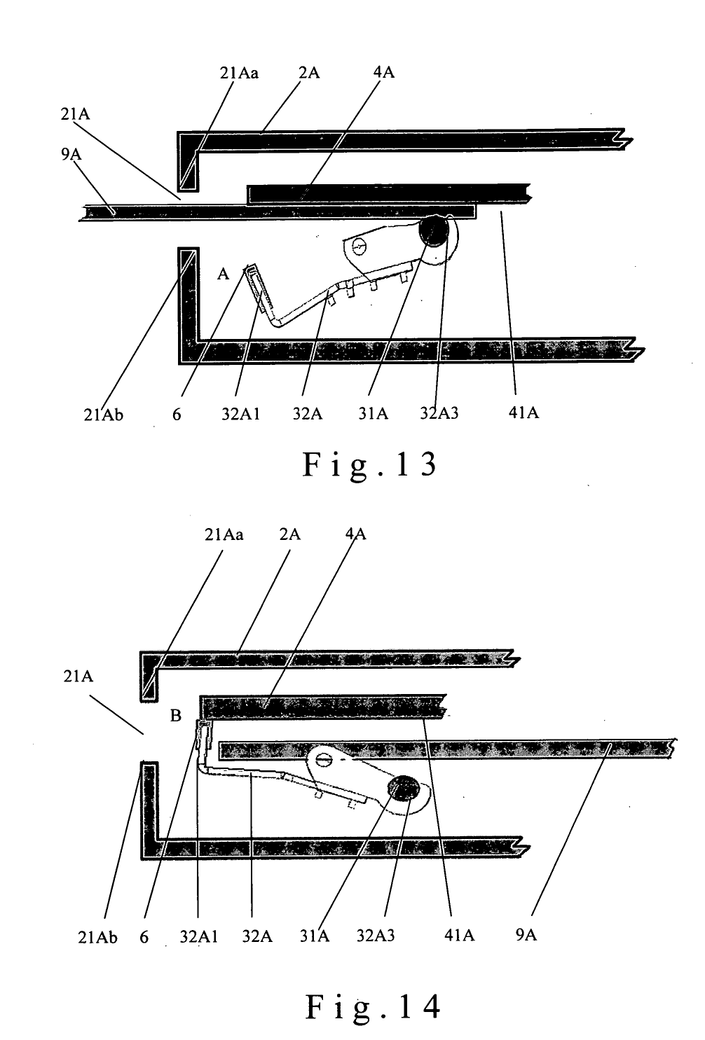

The roller-mounting frame 32A is swingable relative to the casing 2A between a shielding position (reading operation of the disk 9A), in which, the stopping bent ends 32A1, 32A2 of the roller-mounting frame 32A are blocked midway to the disk-traveling route (see FIG. 14) while the transport roller 31A is spaced away from the chassis 4A, and a rotating position (see FIGS. 11 and 13), in which, the stopping bent ends 32A1, 32A2 of the roller-mounting frame 32A are spaced apart from the disk-traveling route while the transport roller 31A is disposed adjacent to the chassis 4A for rotation thereof. Since mounting of the frame 32A on the casing 2A is not related to the relevant feature of the present invention, a detailed description thereof is omitted herein for the sake of brevity.

Referring to FIG. 10, in the first embodiment of the disk drive 1A according to the present invention, the soft flexible member 6 includes two flexible pieces respectively fixed to the upper and lower wall sections 21Aa, 21Ab of the entrance-and-exit slot 21A in the casing 2A.

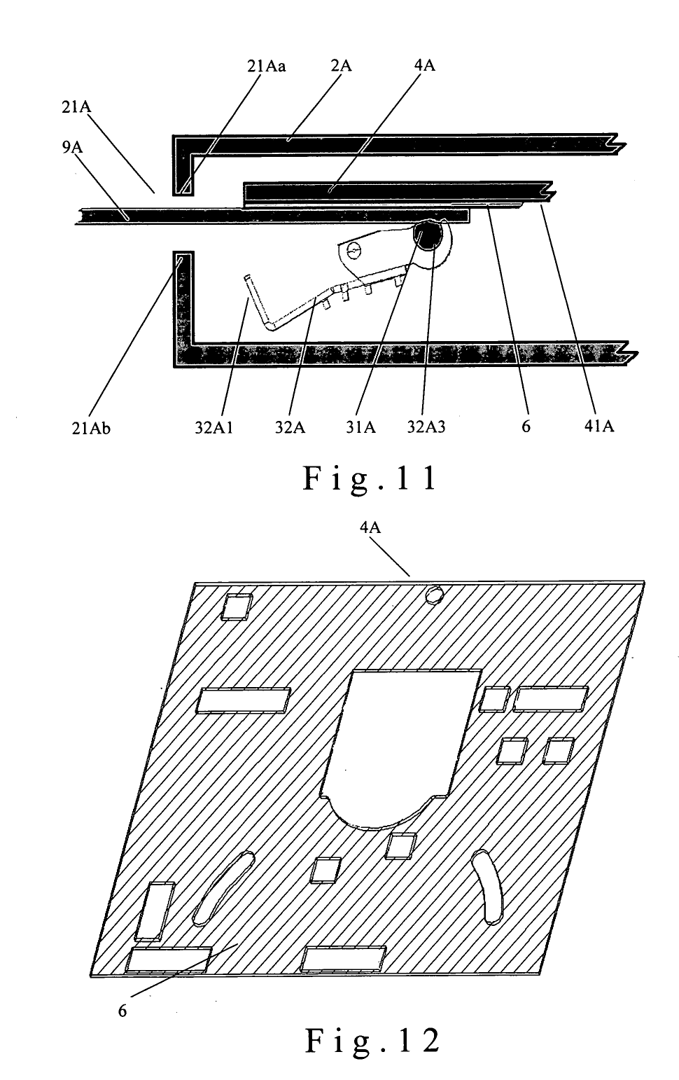

Referring to FIGS. 11 and 12, in the second embodiment of the disk drive 1A according to the present invention, the soft flexible member 6 includes an elongated flexible sheet mounted adhesively on a lower side surface of the chassis 4A.

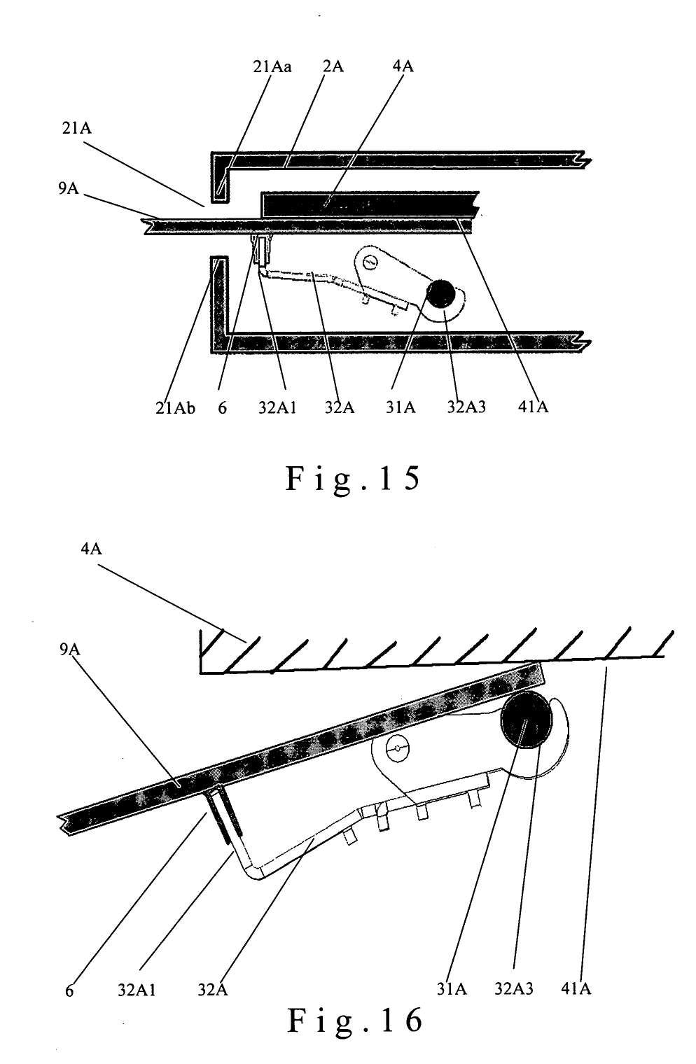

Referring to FIGS. 13 and 14, in the third embodiment of the disk drive 1A according to the present invention, the soft flexible member 6 includes two flexible pieces in the form of sheaths which are respectively sleeved on the bent ends 32A1, 32A2 of the roller-mounting frame 32A such that no damage is done onto the optical disk 9A in case the bent ends 32A1, 32A2 accidentally contact the optical disk 9A during drawing of the disk 9A into or removal of the disk 9A from the casing 2A due to untimely swinging action of the roller-mounting frame 32A relative to the casing 2A or due to gravity of the disk 9A, as shown in FIGS. 15 and 16.

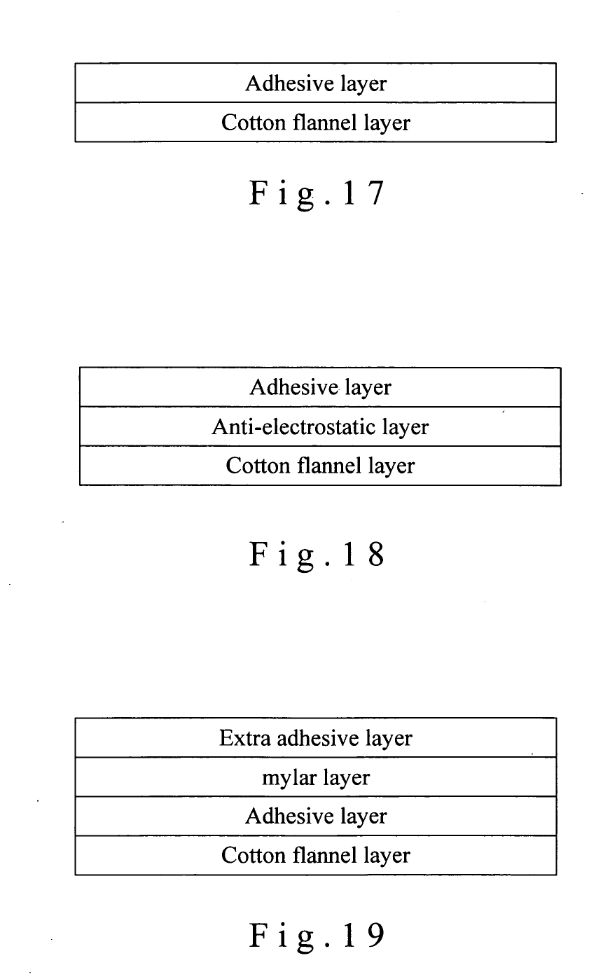

FIG. 17 shows a diagram representing the first embodiment of the flexible member 6, wherein the flexible member 6 includes a cotton flannel layer and an adhesive layer coated on a bottom side of the cotton flannel layer.

FIG. 18 shows a diagram representing the second embodiment of the flexible member 6, wherein the flexible member 6 includes a cotton flannel layer, an anti-electrostatic layer coated on a bottom side of the cotton flannel layer, and an adhesive layer mounted on a bottom side surface of the anti-electrostatic layer.

FIG. 19 shows a diagram representing the third embodiment of the flexible member 6, wherein the flexible member 6 includes a cotton flannel layer, an adhesive layer coated on a bottom side of the cotton flannel layer, a mylar layer mounted on a bottom side surface of the adhesive layer, and an extra adhesive layer mounted on a bottom side surface of the mylar layer.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. An optical disk drive comprising:
a casing having an entrance-and-exit slot;
a chassis disposed stationarily within said casing to extend in a disk-traveling route aligned with said entrance-and-exit slot;
a disk transport mechanism disposed adjacent to and cooperating with said chassis for drawing a disk into said casing and ejecting the disk out of said casing via said entrance-and-exit slot; and
a soft flexible member disposed within said casing adjacent to said disk-traveling route;
wherein said flexible member is adapted to prevent the disk from being scratched during traveling of the disk along said disk-traveling route.

2. The optical disk drive according to claim 1, wherein said disk transport mechanism includes a gear transmission unit mounted on said chassis, a roller-mounting frame mounted swingably to said casing, and a transport roller journalled on said roller-mounting frame and operably connected to said gear transmission unit in such a manner that rotation of said gear transmission unit actuates said transport roller so as to draw the disk into and eject the disk from said casing.

3. The optical disk drive according to claim 2, wherein said roller-mounting frame has two roller-holding arms carrying said transport roller, and two stopping bent ends, said roller-mounting frame being swingable relative to said casing between a shielding position, in which, said stopping bent ends are blocked midway to said disk-traveling route while said transport roller is spaced away from said chassis, and a rotating position, in which, said stopping bent ends of said roller-mounting frame are spaced apart from said disk-traveling route while said transport roller is disposed adjacent to said chassis for rotation thereof.

4. The optical disk drive according to claim 3, wherein said soft flexible member includes two flexible pieces respectively mounted on said stopping bent ends of said roller-mounting frame.

5. The optical disk drive according to claim 1, wherein said soft flexible member includes a flexible sheet mounted securely on a lower side surface of said chassis.

6. The optical disk drive according to claim 1, wherein said entrance-and-exit slot is defined by a slot-confining wall having an upper wall section and a lower wall section, said soft flexible member including two flexible pieces respectively mounted on said upper and lower wall sections of said entrance-and-exit slot.

7. The optical disk drive according to claim 1, wherein said entrance-and-exit slot is defined by a slot-confining wall, said soft flexible member including a flexible piece covering said slot-confining wall of said entrance-and-exit slot.

8. The optical disk drive according to claim 1, wherein said soft flexible member includes a cotton flannel layer.

9. The optical disk drive according to claim 1, wherein said soft flexible member is made from rubber.

10. The optical disk drive according to claim 8, wherein said soft flexible member further includes an adhesive layer coated on a bottom side of said cotton flannel layer.

11. The optical disk drive according to claim 8, wherein said soft flexible member further includes an anti-electrostatic layer coated on a bottom side of said cotton flannel layer, and an adhesive layer coated on a bottom side of said anti-electrostatic layer.

12. The optical disk drive according to claim 8, wherein said soft flexible member further includes an adhesive layer coated on a bottom side of said cotton flannel layer, a mylar layer mounted on a bottom side of said adhesive layer, and an extra adhesive layer mounted on a bottom side of said mylar layer.
